(19) United States
(12) Patent Application Publication
(10) Pub. No.: US 2006/0146227 A1
(43) Pub. Date: Jul. 6, 2006

(54) Prism sheet and liquid crystal display apparatus using thereof

(76) Inventors: Jong-dae Park, Seoul (KR); Kyu-seok Kim, Yongin-si (KR); Sang-hoon Lee, Yongin-si (KR); Jeong-hwan Lee, Suwon-si (KR); Jae-ho Jung, Cheonan-si (KR); Byung-woong Han, Incheon-si (KR)

Correspondence Address: CANTOR COLBURN, LLP, 55 GRIFFIN ROAD SOUTH, BLOOMFIELD, CT, 06002, US

(21) Appl. No.: 11/028,358

(22) Filed: Jan. 3, 2005

(51) Int. Cl. G02F 1/1335

(52) U.S. Cl. 349/64

(57) ABSTRACT

The present invention relates to a prism sheet for a liquid crystal display apparatus having a predetermined pitch on a first side thereof and a plurality of prism mountains formed in parallel with each other, wherein at least one V-shaped groove is formed on a top portion of each of the prism mountains along a lengthwise direction of the prism mountains. Thus, the present invention provides a prism sheet improving vertical incidence with respect to a liquid crystal display panel by concentrating light, and uniformly distributing brightness, and a liquid crystal display apparatus using thereof.

### BACKGROUND OF THE INVENTION

1. Field of the Invention

The present invention relates to a prism sheet and a liquid crystal display apparatus using thereof, and more particularly, to a prism sheet having an improved structure of a prism mountain and a liquid crystal display apparatus using thereof.

2. Description of the Related Art

A liquid crystal display apparatus displays a picture by adjusting the quantity of light received from the outside. Thus, the liquid crystal display apparatus requires an extra light source, namely, a backlight assembly to emit light toward a liquid crystal display panel.

Generally, the backlight assembly comprises an optical sheet to improve brightness of the liquid crystal display panel. The optical sheet comprises a diffusion sheet diffusing light from a light guide plate to the liquid crystal display panel, and a prism sheet provided in front of the diffusion sheet.

Such a prism sheet ununiformly reflects the light from the light guide plate, and concentrates the light to the liquid crystal display panel. Researches are being conducted to improve vertical incidence with respect to the liquid crystal display panel by concentrating light, and to provide uniform brightness distribution.

As a top portion of a prism mountain provided on a first side of the prism sheet is damaged by friction with the liquid crystal display panel disposed in front thereof and other optical sheets, etc, the brightness of the liquid crystal display apparatus or the like is lowered. Thus, researches are also being carried out to minimize damage of the prism sheet.

### SUMMARY OF THE INVENTION

Accordingly, it is an aspect of the present invention to provide a prism sheet improving vertical incidence with respect to a liquid crystal display panel by concentrating light, and uniformly distributing brightness, and a liquid crystal display apparatus using thereof.

Additional aspects and/or advantages of the present invention will be set forth in part in the description which follows and, in part, will be obvious from the description, or may be learned by practice of the present invention.

The foregoing and/or other aspects of the present invention are also achieved by providing a prism sheet for a liquid crystal display apparatus having a predetermined pitch on a first side thereof and a plurality of prism mountains formed in parallel with each other, wherein at least one V-shaped groove is formed on a top portion of each of the prism mountains along a lengthwise direction of the prism mountains.

According to another aspect of the present invention, the V-shaped groove is recessed along a vertical direction of the prism mountains.

According to another aspect of the present invention, the V-shaped groove is consecutively formed on the top portion of each of the prism mountains to shape a triangular waveform on the top portion thereof.

The foregoing and/or other aspects of the present invention are also achieved by providing a liquid crystal display apparatus comprising: a liquid crystal display panel; a lamp emitting light; a light guide plate provided behind the liquid crystal display panel and emitting the light from the lamp toward the liquid crystal display panel; and an optical sheet provided between the liquid crystal display panel and the light guide plate, the optical sheet comprising at least one prism sheet having a predetermined pitch on a first side thereof and a plurality of prism mountains formed in parallel with each other, and at least one V-shaped groove being formed on a top portion of each of the prism mountains on at least one prism sheet along a lengthwise direction of the prism mountains.

According to another aspect of the present invention, the V-shaped groove of the prism sheet is recessed along a vertical direction of the prism mountains.

According to another aspect of the present invention, the V-shaped groove of the prism sheet is consecutively formed on the top portion of each of the prism mountains to shape the triangular waveform on the top portion thereof.

According to another aspect of the present invention, the prism mountains formed on any of the prism sheets face the back of the liquid crystal display panel.

According to another aspect of the present invention, the prism sheets are provided as a pair behind the liquid crystal display panel, and the prism mountains of the pair of prism sheets cross each other.

According to another aspect of the present invention, on a back of the light guide plate are formed a plurality of prism mountains having a predetermined pitch, and the prism sheets are arranged such that the prism mountains of the prism sheets face a front surface of the light guide plate.

According (to another aspect of the present invention, the prism mountains of the light guide plate and the prism mountains of the prism sheets cross each other.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is an exploded perspective view of a liquid crystal display apparatus according to an embodiment of the present invention;

FIG. 2 is a sectional view of FIG. 1, taken along II-II; and

FIG. 3 is an exploded perspective view of the liquid crystal display apparatus according to another embodiment of the present invention.

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout.

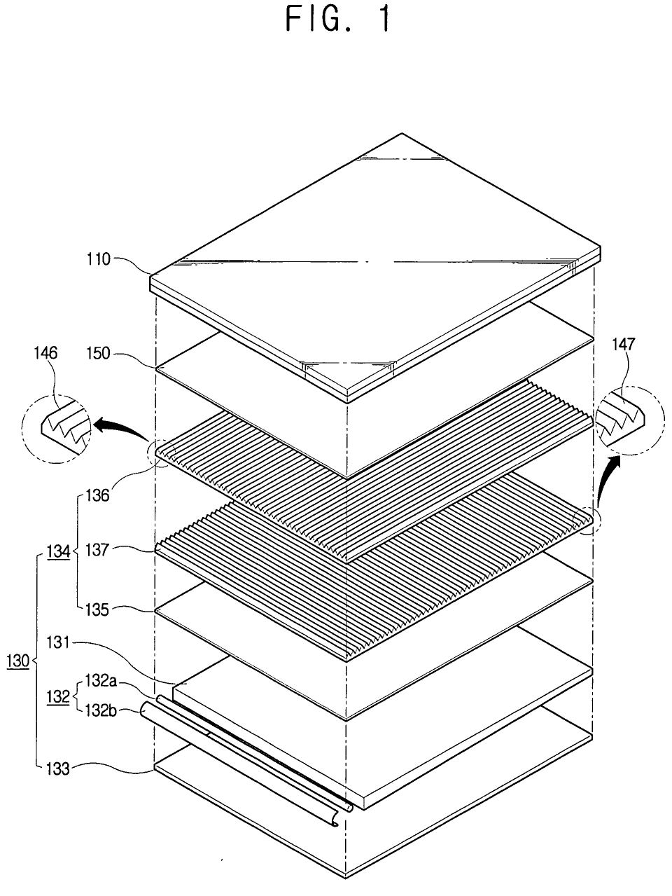

FIG. 1 is an exploded perspective view of a liquid crystal display apparatus according to the present invention. As shown therein, the liquid crystal display apparatus according to the present invention comprises a liquid crystal display panel 10 displaying a picture thereon; and a backlight assembly 30 emitting light toward the liquid crystal display panel 10. The liquid crystal display panel 10 and the backlight assembly 30 are accommodated and supported by a front casing and a rear casing (not shown).

The liquid crystal display panel 10 comprises a TFT (thin film transistor) substrate (not shown) formed with a switching element (not shown) and a pixel electrode (not shown), etc; and a liquid crystal provided between a color filter substrate (not shown) and two other substrates. An image signal is applied to a transistor of the TFT substrate via an IC driver thereof, and the liquid crystal forms a picture by light from the backlight assembly 30 after electrically receiving a signal.

The backlight assembly 30 comprises a lamp unit 32 generating light; a light guide plate 31 converting the light from the lamp unit 32 into a surface light source; a reflection plate 33 provided behind the light guide plate 31 and returning the light from the light guide plate 31 to the light guide plate 31; an optical sheet 34 provided in front of the light guide plate 31; and a supporting frame (not shown) accommodating and supporting the lamp unit 32, the light guide plate 31 and the optical sheet 34.

The lamp unit 32 is provided on a first side of the light guide plate 31, and comprises a lamp 32a provided as a light source and a lamp reflection plate 32b improving light efficiency by reflecting the light toward the light guide plate 31, which are not directly emitted toward the light guide plate 31 among the light generated from the lamp 32a. In general, a CCFL (cold cathode fluorescent lamp) is used for the lamp 32a.

The light guide plate 31 is provided behind the liquid crystal display panel 10, converts the light from the lamp 32a into the surface light source, and emits the light toward the liquid crystal display panel 10. The light guide plate 31 is formed by a plastic transparent material such as acryl, and emits the light generated from the lamp 32a toward the liquid crystal display panel 10 disposed in front of the light guide plate 31. Accordingly, on a lower surface of the light guide plate 31 are printed various patterns such as a fine dot pattern to change a direction of the light generated from the lamp 32a to the liquid crystal display panel 10.

The reflection plate 33 is provided behind the light guide plate 31, and returns the light from the light guide plate 31 to the light guide plate 31. That is, the reflection plate 33 returns the light to the light guide plate 31 which is not reflected by the dot pattern, etc, of the light guide plate 31 among the light from the lamp 32a, thereby minimizing loss of light.

The optical sheet 34 comprises a diffusion sheet 35 diffusing the light coming out through the light guide plate 31 to the liquid crystal display panel 10; and prism sheets 36 and 37 provided in front of the diffusion sheet 35. Hereinbelow, the optical sheet 34 having the two prism sheets 36 and 37 will be described as an example, and the two prism sheets 36 and 37 sequentially disposed from a back of the liquid crystal display panel 10 will be named as a first prism sheet 36 and a second prism sheet 37 respectively.

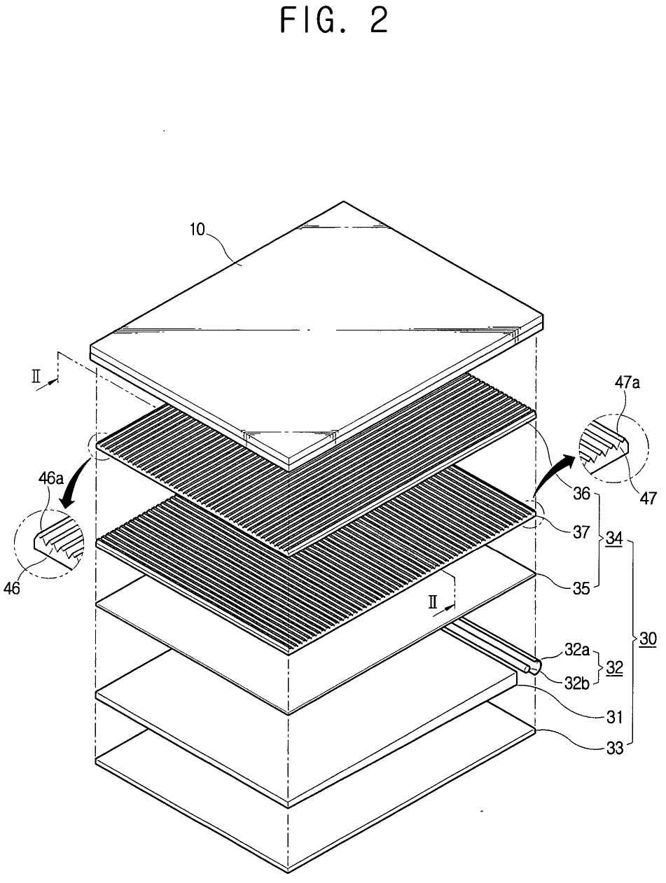

On a surface of the first prism 36 and a surface of the second prism 37 facing the liquid crystal display panel 10, are provided a plurality of prism mountains 46 and 47 having a predetermined pitch P (referring to FIG. 2) and formed in parallel with each other. Here, the prism mountain 46 of the first prism sheet 36 and the prism mountain 47 of the second prism sheet 37 are provided on the back of the liquid crystal display panel 10 to cross each other.

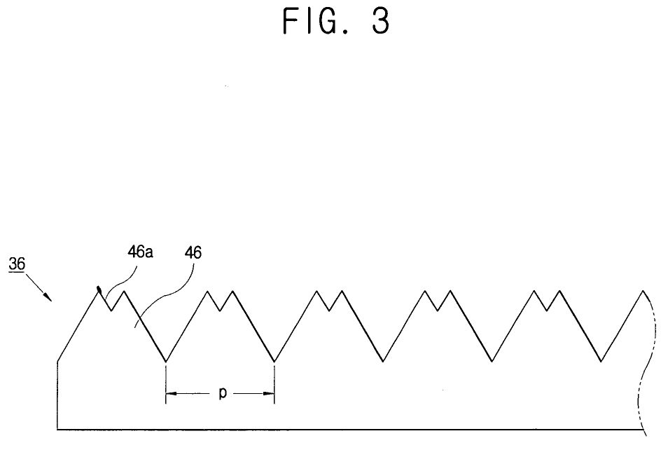

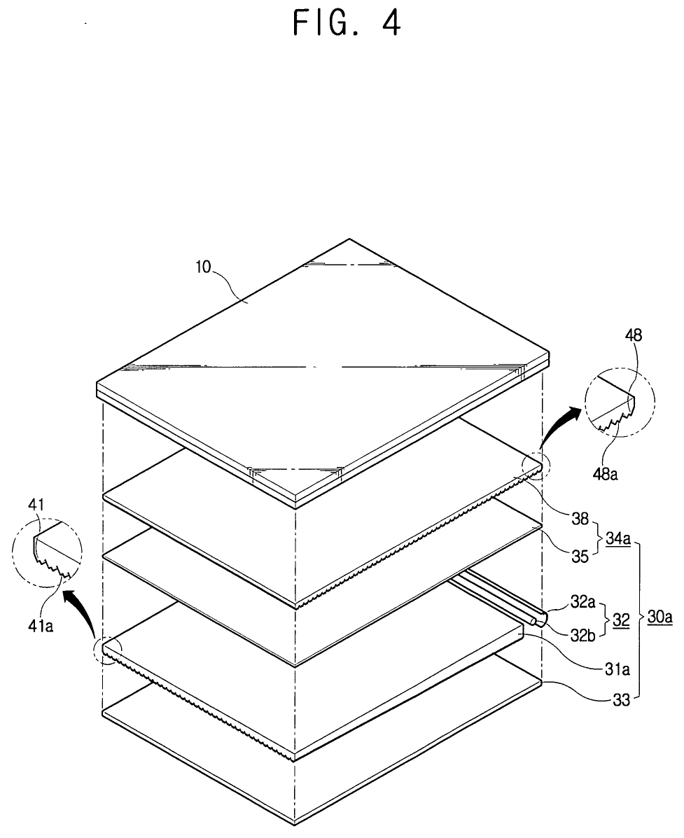

As shown in FIG. 3, on each top portion of the prism mountain 46 of the first prism sheet 36 is formed at least one V-shaped groove 46a along a lengthwise direction of the prism mountain 46. As a plurality of peaks are formed on the prism mountain 46, the light diffused by the diffusion sheet 35 is concentrated and the vertical incidence with respect to the liquid crystal display panel 10 is improved, thereby uniformly distributing brightness.

Here, the V-shaped groove 46a formed on the top of the prism mountain 46 of the first prism sheet 36 is recessed along a vertical direction of the prism mountain 46. FIG. 2 illustrates the prism mountain 46 forming one V-shaped groove 46a thereon. Alternatively, the V-shaped groove may be consecutively formed on the top portion of each prism mountain to shape a triangular waveform thereon. With this configuration, even though one of the plurality of the peaks formed by the plurality of the V-shaped grooves is damaged by friction with the liquid crystal display panel 10 disposed in front thereof, loss of light concentration, vertical incidence and uniform brightness distribution are minimized.

Meanwhile, also the second prism sheet 37 may form a V-shaped groove 47a same as that of the first prism sheet 36.

FIG. 3 is an exploded perspective view of a liquid crystal display apparatus according to another embodiment of the present invention. As shown therein, a liquid crystal display apparatus 10 comprises a lamp unit 32 generating light; a light guide plate 31a converting the light from the lamp unit 32 into a surface light source; a reflection plate 33 provided behind the light guide plate 31a and returning the light from the light guide plate 31a to the light guide plate 31a; and an optical sheet 34a provided between the liquid crystal display panel 10 and the light guide plate 31a.

The optical sheet 34a comprises a prism sheet 38 (referred to as “reverse prism sheet” hereinbelow) formed with a plurality of prism mountains 48 protruding in parallel from a surface facing the light guide plate 31a and having a predetermined pitch. On a top portion of each of the prism mountain 48 of the reverse prism sheet 38 is formed at least one V-shaped groove 48a along a lengthwise direction of the prism mountain 48. As a plurality of peaks are formed on the prism mountain 48, the light from the light guide plate 31a is concentrated and vertical incidence with respect to the liquid crystal display panel 10 is improved, thereby uniformly distributing brightness.

The V-shaped groove 48a formed on the top portion of the prism mountain 48 of the reverse prism sheet 38 is recessed along a vertical direction of the prism mountain 48. FIG. 3 illustrates the prism mountain 48 forming one V-shaped groove 48a on each of the prism mountain 48. Alternatively, the V-shaped groove may be consecutively formed on the top portion of each prism mountain to shape a triangular waveform thereon. With this configuration, even though one of the plurality of the peaks formed by the plurality of the V-shaped grooves is damaged by friction with the light guide plate 31a disposed therebehind, loss of light concentration, vertical incidence and uniform brightness distribution are minimized.

Meanwhile, on a back of the light guide plate 31a facing the reflection plate 33 are formed a plurality of prism mountains 41 having a predetermined pitch and formed in parallel with each other. In the liquid crystal display apparatus according to another embodiment of the present invention, the prism mountain 41 of the light guide plate 31a and the prism mountain 48 of the reverse prism sheet 38 are provided to cross each other. Also, on the prism mountain 41 of the light guide plate 31 is formed at least one V-shaped groove 41a along a lengthwise direction of the prism mountain 41 on the top portion thereof same as the prism mountain 48 of the reverse prism sheet 38.

The V-shaped groove 41a formed on the top portion of the prism mountain 41 of the light guide plate 31a is recessed along a vertical direction of the prism mountain 41. FIG. 3 illustrates the prism mountain 41 forming one V-shaped groove 41a on each of the prism mountain 41. Alternatively, the V-shaped groove may be consecutively formed on the top portion of each prism mountain to shape a triangular waveform thereon. With this configuration, even though one of the plurality of the peaks formed by the plurality of the V-shaped grooves is damaged by the friction with the reflection plate 33 disposed therebehind, loss of light concentration, vertical incidence and uniform brightness distribution are minimized.

In the foregoing embodiments, the prism mountains 46 and 47 of the first prism sheet 36 and the second prism sheet 37, and the prism mountains 41 and 48 of the light guide plate 31a and the reverse prism sheet 38 are formed with the V-shaped grooves 41a, 46a, 47a and 48a. Alternatively, either on the top portion of the first prism sheet 36 or on the top portion of the second prism sheet 37 may be formed the V-shaped groove. Also, either on the top portion of the light guide plate 31 or on the top portion of the reverse prism sheet 38 may be formed the V-shaped groove.

In the foregoing embodiments, the optical sheets 34 and 34a comprise the prism sheets 36, 37, and 38, and the diffusion sheet 35. Alternatively, the optical sheets 34 and 34a may comprise various optical sheets or films such as a protection film provided between the liquid crystal display panel 10 and the first prism sheet 36 to prevent scratch by the prism mountains.

By forming at least one of the V-shaped grooves 46a, 47a and 48a on the top portion of each of the prism mountains 46, 47 and 48 provided on the prism sheets 36, 37 and 38 along a lengthwise direction thereof, the light is concentrated and the vertical incidence with respect to the liquid crystal display panel 10 is improved, thereby uniformly distributing the brightness.

Also, as the V-shaped grooves are consecutively formed on the top portion of the prism mountains 46, 47 and 48 to shape the triangular waveform on the top portion thereof, loss of the light concentration, the vertical incidence and the uniform brightness distribution are minimized even if one of the plurality of the peaks formed by the plurality of the V-shaped grooves is damaged by the friction with the liquid crystal display panel or the optical sheet, etc.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A prism sheet for a liquid crystal display apparatus having a predetermined pitch on a first side thereof and a plurality of prism mountains formed in parallel with each other, wherein at least one V-shaped groove is formed on a top portion of each of the prism mountains along a lengthwise direction of the prism mountains.

2. The prism sheet for the liquid crystal display apparatus according to claim 1, wherein the V-shaped groove is recessed along a vertical direction of the prism mountains.

3. The prism sheet for the liquid crystal display apparatus according to claim 1, wherein the V-shaped groove is consecutively formed on the top portion of each of the prism mountains to shape a triangular waveform on the top portion thereof.

4. A liquid crystal display apparatus comprising: a liquid crystal display panel; a lamp emitting light; a light guide plate provided behind the liquid crystal display panel and emitting the light from the lamp toward the liquid crystal display panel; and an optical sheet provided between the liquid crystal display panel and the light guide plate,
the optical sheet comprising at least one prism sheet having a predetermined pitch on a first side thereof and a plurality of prism mountains formed in parallel with each other, and
at least one V-shaped groove being formed on a top portion of each of the prism mountains on at least one prism sheet along a lengthwise direction of the prism mountains.

5. The liquid crystal display apparatus according to claim 4, wherein the V-shaped groove of the prism sheet is recessed along a vertical direction of the prism mountains.

6. The prism sheet for the liquid crystal display apparatus according to claim 4, wherein the V-shaped groove of the prism sheet is consecutively formed on the top portion of each of the prism mountains to shape the triangular waveform on the top portion thereof.

7. The liquid crystal display apparatus according to claim 4, wherein the prism mountains formed on any of the prism sheets face the back of the liquid crystal display panel.

8. The liquid crystal display apparatus according to claim 5, wherein the prism sheets are provided as a pair behind the liquid crystal display panel, and the prism mountains of the pair of prism sheets cross each other.

9. The liquid crystal display apparatus according to claim 4, wherein on a back of the light guide plate are formed a plurality of prism mountains having a predetermined pitch, and the prism sheets are arranged such that the prism mountains of the prism sheets face a front surface of the light guide plate.

10. The liquid crystal display apparatus according to claim 9, wherein the prism mountains of the light guide plate and the prism mountains of the prism sheets cross each other.
